(19) United States
(12) Patent Application Publication
(10) Pub. No.: US 2018/0285822 A1
(43) Pub. Date: Oct. 4, 2018

(54) RANKING JOB OFFERINGS BASED ON CONNECTION MESH STRENGTH

(71) Applicant: Linkedln Corporation, Sunnyvale, CA (US)

(72) Inventors: Krishnaram Kenthapadi, Sunnyvale, CA (US); Kaushik Rangadurai, Sunnyvale, CA (US)

(21) Appl. No.: 15/478,802

(22) Filed: Apr. 4, 2017

(51) Int. Cl. G06Q 10/10; G06Q 50/00; G06F 17/30

(52) U.S. Cl. CPC G06Q 10/1053; G06F 17/3053; G06Q 50/01

(57) ABSTRACT

Methods, systems, and computer programs are presented for selecting jobs for a user based on the connections of the user in a social network. A method includes determining, on a social network, connection strengths between members of the social network and members that have currently or previously worked for a company offering a job. For each job, a server determines a leverage score representing the anticipated ability of a job-seeker to contact members of the social network to improve the chances of the job-seeker attaining the job. The server additionally ranks the jobs within a connection-leverage group for the user based on the leverage score for each job.

### TECHNICAL FIELD

The subject matter disclosed herein generally relates to methods, systems, and programs for finding quality job offerings for a member of a social network.

### BACKGROUND

Some social networks provide job postings to their members. The member may perform a job search by entering a job search query, or the social network may suggest jobs that may be of interest to the member. However, current job search methods may miss valuable opportunities for a member because the job search engine limits the search to specific parameters. For example, the job search engine may look for matches of a job in the title of the job to the member's title, but there may be quality jobs that are associated with a different title that would be of interest to the member.

Further, existing job search methods may focus only on the job description or the member's profile, without considering the member's preferences for job searches that go beyond the job description or other information that may help find the best job postings for the member.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a network architecture, according to some example embodiments, including a social networking server.

FIG. 2 is a screenshot of a user interface that includes job recommendations, according to some example embodiments.

FIG. 3 is a screenshot of a user's profile view, according to some example embodiments.

FIG. 4 is a diagram of a user interface, according to some example embodiments, for presenting job postings to a member of a social network.

FIG. 5 is a detail of a connection-leverage group area in a user interface, according to some example embodiments.

FIG. 6A illustrates the scoring of a job for a member, according to some example embodiments.

FIG. 6B further shows scoring the job for the member while incorporating groups, in some embodiments.

FIG. 7 is a network map illustrating various connections between members on a social network, according to some example embodiments.

FIG. 8 is a network map, according to some example embodiments, illustrating layers of members connected to a member and showing members that have a relationship with a company.

FIG. 9 is a network map, according to some example embodiments, illustrating a scoring process for generating a leverage score based on connection strengths between members.

FIG. 10 illustrates the training and use of a machine-learning program, according to some example embodiments.

FIG. 11 illustrates a method for identifying similarities among member skills, according to some example embodiments.

FIG. 12 is an additional illustration of a method for assigning a leveraging score in response to a search for a member in some example embodiments.

FIG. 13 illustrates the network leveraging system for implementing example embodiments.

FIG. 14 is a flowchart of a method, according to some example embodiments, for selecting jobs for a user based on the connections of the user in a social network.

FIG. 15 is a block diagram illustrating an example of a software architecture that may be installed on a machine, according to some example embodiments.

FIG. 16 is a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are directed to selecting jobs for a user based on the connections of the user in a social network. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

One of the goals of the present embodiments is to personalize and redefine how job postings are searched and presented to job seekers. Another goal is to explain better why particular candidate jobs are recommended to the job seekers. The presented embodiments provide, to both active and passive job seekers, valuable job recommendation insights, thereby greatly improving their ability to find and assess jobs that meet their needs.

Instead of providing a single job recommendation list for a member, embodiments presented herein define a plurality of groups, and the job recommendations are presented within the groups. Each group provides an indication of a feature that is important to the member for selecting from the group, such as how many people have transitioned from the university of the member to the company of the job, who would be a virtual team for the member if the member joined the company, jobs offered by companies with employees connected to the user, and so forth. Thus, the embodiments are able to provide insight into the methods of job selection to the user by providing groups of jobs, with all jobs in the group sharing one or more features. Thus, the user is given insight into why certain jobs are presented within a particular group.

Embodiments presented herein assess members that a member has connected with (connected members) on a social network to assist the member in leveraging these relationships to attain a job at a company (i.e., asking for a recommendation). Specifically, the system focuses on connected members of the member that currently are employed at, or were formerly an employee of, a company that is offering a job sought by the first member. Based on the strength of the member's connection to the connected members and the relationships of the connected members to the company, a leverage score can be generated for each company. Thus, the leverage score can be presented to a member of an anticipated ability of the member to leverage his or her social network to attain the job. It should be appreciated that “employee” and “company connected member,” as referred to herein, include both former employees of the company and current employees of the company unless distinguished.

One general aspect includes a method for identifying, by a server having at least one processor, jobs presentable to a member in response to a search for jobs for the member, each job being offered by one of a plurality of companies. The method also includes operations for identifying connected members of the member in a social network, each connected member being associated with a connection strength. The method also includes operations for identifying company connected members as the connected members of the first member. The method also includes operations for calculating a leverage score for the company based on connection strengths of the company connected members. The method also includes operations for calculating a leverage score for the company based on the connection strengths of the company connected members. The method also includes operations to rank the jobs based on the leverage scores and operations for presenting the jobs within a cultural fit group area in an order based on the ranking. In other embodiments, a system or machine-readable medium may perform operations similar operations to the above method.

In some embodiments the connected members include a subset of primary connected members and a subset of secondary connections, a primary connected member being a member on the social network that has connected with the member on the social network and a secondary connected member being a member on the social network that has connected with at least one of the plurality of primary connected members of the member, and wherein the connection strength is further based on the connected members being primary or secondary members and on connections between the primary and the secondary members. Further, the leverage score for a company can be calculated based on the subset of primary connected members and the connections of company connected members.

In some embodiments, the operations further include determining a first skill set for the first member based on skills included in a profile of the first member and determining a skill set for each of the connected members based on skills included in profiles of the connected members and where the connection strength between the first member and each connected member is based on the connected member having the similar skills as the first skill set. In some embodiments, the connection strength between the member and each connected member is calculated based on a job title of the respective connected member. In some embodiments, the operations further include determining a network affinity between the first member and the company based on network interactions and wherein the calculating a leverage score for the company is based on the connection strengths of the company connected members and the network affinity of the first member and the company. In some embodiments, the network interactions include social interactions between the first member and the company connected members. In some embodiments, the operations further include determining a skill set for the member, identifying proxy members also having skills similar to the skill set, providing the proxy member with survey questions, and receiving answers from the proxy member, wherein the answers are used as network interactions.

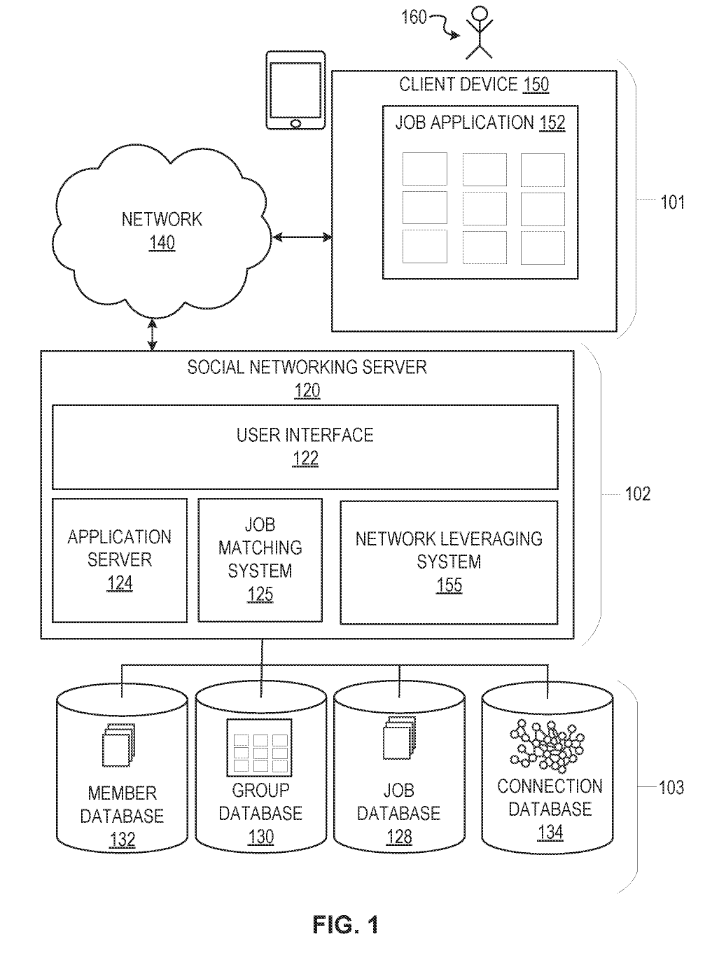

FIG. 1 is a block diagram illustrating a network architecture, according to some example embodiments, including a social networking server 120. As shown in FIG. 1, the network architecture includes three layers: a data layer 103, an application logic layer 102, and a device layer 101. The layers communicate over a network 140 (e.g., the Internet). The data layer 103 includes several databases, including a member database 132 for storing data for various entities of the social networking server 120, including member profiles, company profiles, and educational institution profiles, as well as information concerning various online or offline groups. Of course, in various alternative embodiments, any number of other entities might be included in the social graph, and as such, various other databases may be used to store data corresponding with other entities.

Consistent with some embodiments, when a person initially registers to become a member of the social networking server 120, the person will be prompted to provide some personal information, such as his or her name, age (e.g., birth date), gender, interests, contact information, home town, address, spouse's and/or family members' names, educational background (e.g., schools, majors, etc.), current job title, job description, industry, employment history, skills, professional organizations, interests, and so on. This information is stored, for example, as member attributes in the member database 132.

Additionally, the data layer 103 includes a job database 128 for storing job data. The job data includes information collected from a company offering a job, including experience required, location, duties, pay, and other information. This information is stored, for example, as job attributes in the job database 128,

Additionally, the data layer 103 includes a connection database 134 for storing data related to the strength of company connected members. The company data includes company information, such as company name, industry associated with the company, number of employees at the company, address of the company, overview description of the company, and job postings associated with the company. Additionally, the company data includes a benefit value that measures benefits experienced by employees that work for the company. The benefit value may be determined by assessing various features, including the provision of company meals, rate of promotion within the company, vacation time, and starting salary.

Once registered, a member may invite other members, or be invited by other members, to connect via the social networking server 120. A “connection” may specify a bilateral agreement by the members, such that both members acknowledge the establishment of the connection. Each of the members thus becomes a “connected member” of the other, since the connection between them is established. Similarly, in some embodiments, a member may elect to “follow” another member. In contrast to establishing a connection, the concept of “following” another member typically is a unilateral operation, and at least in some embodiments, does not prompt acknowledgement or approval by the member who is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking server 120. In some example embodiments, because the content selection algorithm selects content relating to or associated with the particular entities that a member is connected with or is following, as a member connects with and/or follows other entities, the universe of available content items for presentation to the member in his or her content stream increases.

Additionally, the data layer 103 includes a group database 130 for storing group data. The group database 130 includes information about groups (e.g., clusters) of jobs that have job attributes in common with each other. The group data includes various group features comprising a characteristic for the group, as discussed in more detail below. This information is stored, for example, as job attributes in the job database 128.

As members interact with various applications, content, and user interfaces of the social networking server 120, information relating to the member's activity (i.e., browsing data) and behavior may be stored in a database, such as the member database 132 and the job database 128.

The social networking server 120 may provide a broad range of other applications and services that allow members the opportunity to share and receive information, often customized to the interests of the member. In some embodiments, members of the social networking server 120 may be able to self-organize into groups, or interest groups, organized around a subject matter or a topic of interest. In some embodiments, members may subscribe to or join groups affiliated with one or more companies. For instance, in some embodiments, members of the social networking server 120 may indicate an affiliation with a company at which they are employed, such that news and events pertaining to the company are automatically communicated to the members in their personalized activity or content streams. In some embodiments, members may be allowed to subscribe to receive information concerning companies other than the company with which they are employed. Membership in a group, a subscription or following relationship with a company or group, and an employment relationship with a company are all examples of different types of relationships that may exist between different entities, as defined by the social graph and modeled with social graph data of the member database 132.

The application logic layer 102 includes various application server modules 124, which, in conjunction with a user interface module 122, generate various user interfaces with data retrieved from various data sources or data services in the data layer 103. In some embodiments, individual application server modules 124 are used to implement the functionality associated with various applications, services, and features of the social networking server 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, the social networking server 120 may include a job matching system 125, which creates a job display on a job application 152 on a client device 150. Also included in the social networking server 120 is a group ranking and network-leveraging system 155, which causes the job application 152 to display personalized groups that include job postings viewable by a member 160.

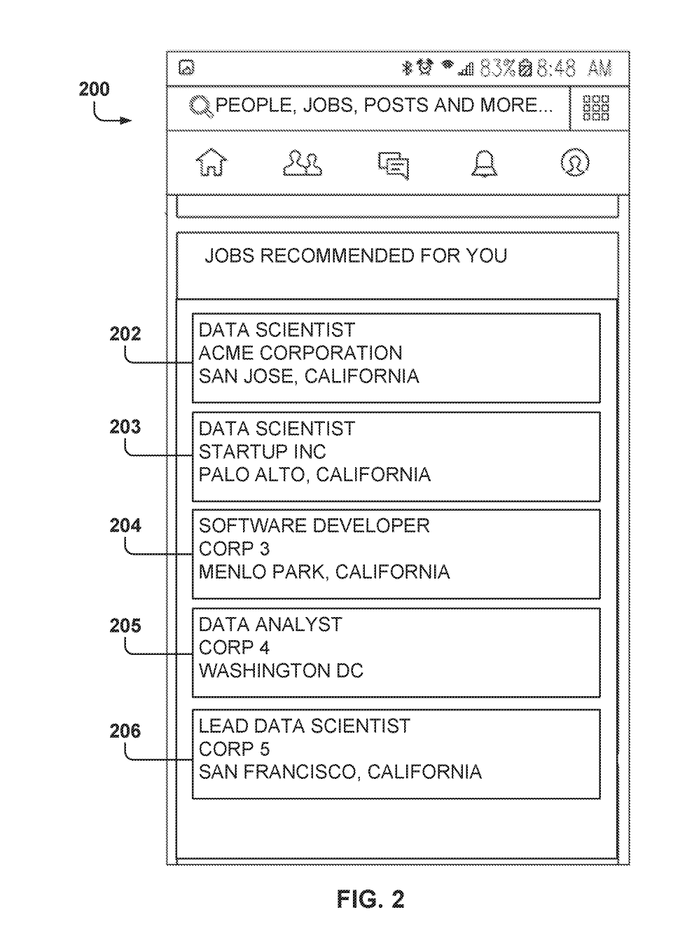

FIG. 2 is a screenshot of a user interface 200 that includes recommendations for jobs 202-206 within the job application 152, according to some example embodiments. In one example embodiment, the social network user interface 200 provides job recommendations, which are job postings that match the job interests of the user and that are presented without a specific job search request from the user (e.g., job suggestions).

In another example embodiment, a job search interface is provided for entering job searches, and the resulting job matches are presented to the user in the user interface 200.

As the user scrolls down the user interface 200, more job recommendations are presented to the user. In some example embodiments, the job recommendations are prioritized to present jobs in an estimated order of interest to the user.

The user interface 200 presents a “flat” list of job recommendations as a single list. Other embodiments presented below utilize a “segmented” list of job recommendations where each segment is a group that is associated with a related reason indicating why these jobs are being recommended within the group.

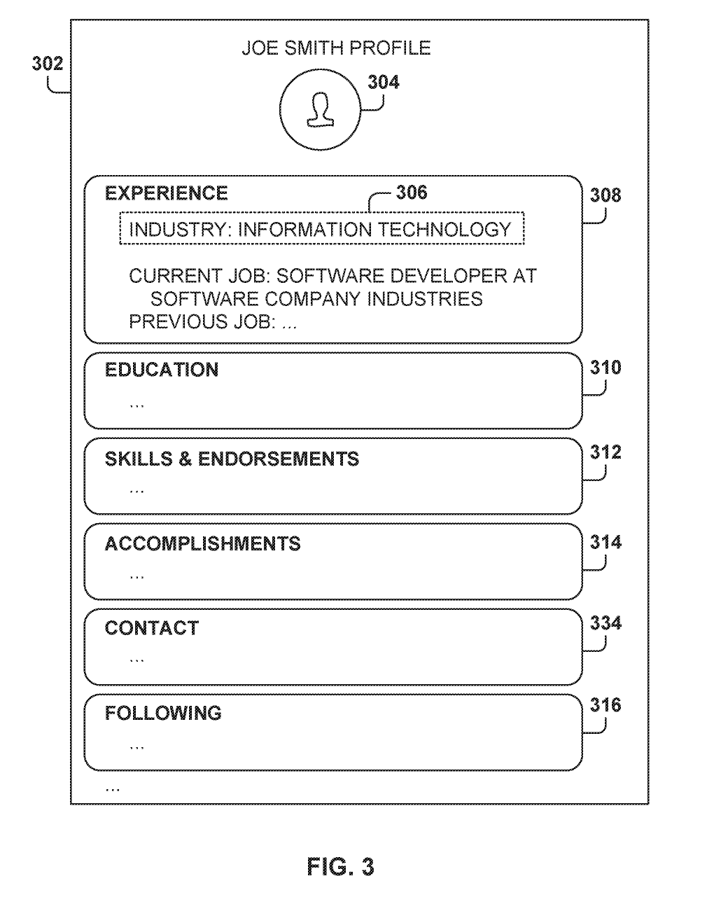

FIG. 3 is a screenshot of a user's profile view, according to some example embodiments. Each user in the social network has a member profile 302, which includes information about the user. The member profile 302 is configurable by the user and also includes information based on the user's browsing data in the social network (e.g., likes, posts read).

In one example embodiment, the member profile 302 may include information in several categories, such as a profile picture 304, experience 308, education 310, skills and endorsements 312, accomplishments 314, contact information 334, following 316, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the member's account is associated with the number of endorsements received for each skill from other members.

The experience 308 information includes information related to the professional experience of the user. In one example embodiment, the experience 308 information includes an industry 306, which identifies the industry in which the user works. In one example embodiment, the user is given an option to select an industry 306 from a plurality of industries when entering this value in the member profile 302. The experience 308 information area may also include information about the current job and previous jobs held by the user.

The education 310 information includes information about the educational background of the user, including the educational institutions attended by the user, the degrees obtained, and the field of study of the degrees. For example, a member may list that the member attended the University of Michigan and obtained a graduate degree in computer science. For simplicity of description, the embodiments presented herein are presented with reference to universities as the educational institutions, but the same principles may be applied to other types of educational institutions, such as high schools, trade schools, professional training schools, and the like.

The skills and endorsements 312 information includes information about professional skills that the user has identified as having been acquired by the user and endorsements entered by other users of the social network supporting the skills of the user. The accomplishments 314 area includes accomplishments entered by the user, and the contact information 334 includes contact information for the user, such as an email address and phone number. The following 316 area includes the names of entities in the social network being followed by the user.

The skills within the skills and endorsements 312 information are aggregated by the system to form a skill set for the user that can be compared to other users. In some embodiments, this skill set is part of a member characteristic for the user, the member characteristic including information such as the skill set for the user, profile information, education 310 information, and other data that is further comparable to other members.

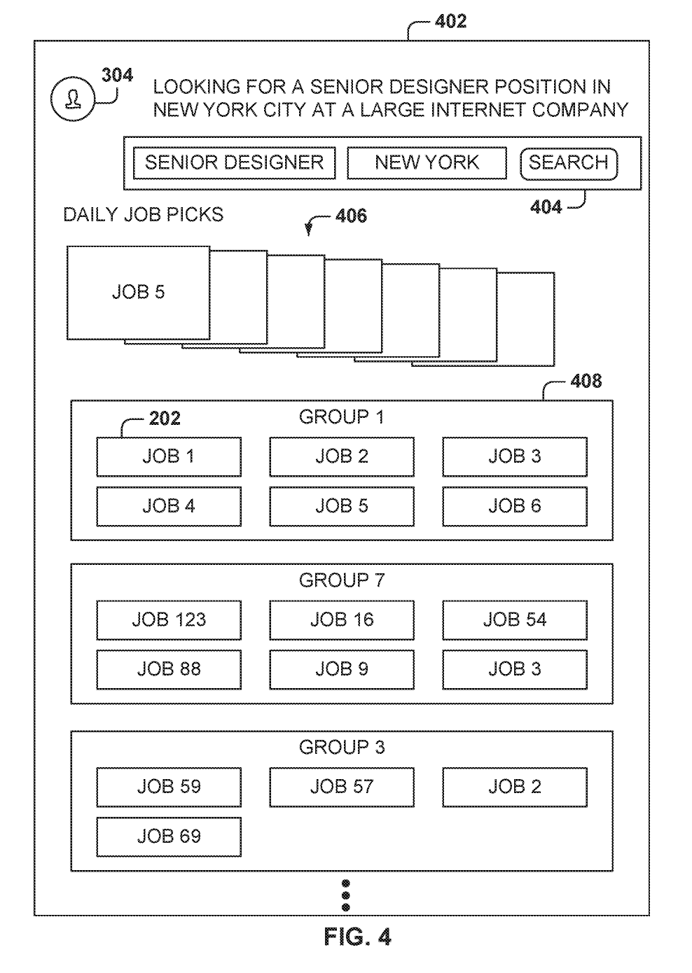

FIG. 4 is a diagram of a user interface 402, according to some example embodiments, for presenting job postings to a member of the social network. The user interface 402 includes the profile picture 304 of the member, a search section 404, a daily jobs section 406, and one or more group areas 408. In some example embodiments, a message next to the profile picture 304 indicates the goal of the search, e.g., “Looking for a senior designer position in New York City at a large Internet company.”

The search section 404, in some example embodiments, includes two boxes for entering search parameters: a keyword input box for entering any type of keywords for the search (e.g., job title, company name, job description, skill, etc.), and a geographic area input box for entering a geographic area for the search (e.g., New York). This allows members to execute searches based on keyword and location. In some embodiments, the geographic area input box includes one or more of city, state, ZIP code, or any combination thereof.

In some example embodiments, the search boxes may be prefilled with the user's title and location if no search has been entered yet. Clicking the search button causes the search of jobs based on the keyword inputs and location. It is to be noted that the inputs are optional, and only one search input may be entered at a time, or both search boxes maybe filled in.

The daily jobs section 406 includes information about one or more jobs selected for the user, based on one or more parameters, such as member profile data, search history, job match to the member, recentness of the job, whether the user is following the job, and so forth.

Each group area (such as a connection-leverage group area 408) includes one or more jobs 202 for presentation in the user interface 402. In one example embodiment, the group area 408 includes one to six jobs 202 with an option to scroll the group area 408 to present additional jobs 202, if available.

Each group area provides an indication of why the member is being presented with those jobs 202, which identifies the characteristic of the group. There could be several types of reasons related to the connection of the user to a job, the affinity of the member to the group, the desirability of the job, or the time deadline of the job (e.g., urgency). The reasons related to the connection of the user to the job may include relationships between the job and the connected members of the member (e.g., “Your connections can refer you to this set of jobs”), a quality of a fit between the job and the user characteristics (e.g., “This is a job from a company that hires from your school”), a quality of a match between the member's talent and the job (e.g., “You would be in the top 90% of all applicants), and so forth.

Further, the group characteristics may be implicit (e.g., “These jobs are recommended based on your browsing history”) or explicit (e.g., “These are jobs from companies you followed”). The desirability reasons may include popularity of the job in the member's area (e.g., most-viewed by other members or most applications received), jobs from in-demand start-ups in the member's area, and popularity of the job among people with the same title as the member. Further yet, the time-urgency reasons may include “Be the first to apply to these jobs” or “These jobs will be expiring soon.”

It is to be noted that the embodiments illustrated in FIG. 4 are examples and do not describe every possible embodiment. Other embodiments may utilize different layouts or groups, present fewer or more jobs, present fewer or more groups, etc. The embodiments illustrated in FIG. 4 should therefore not be interpreted to be exclusive or limiting, but rather illustrative.

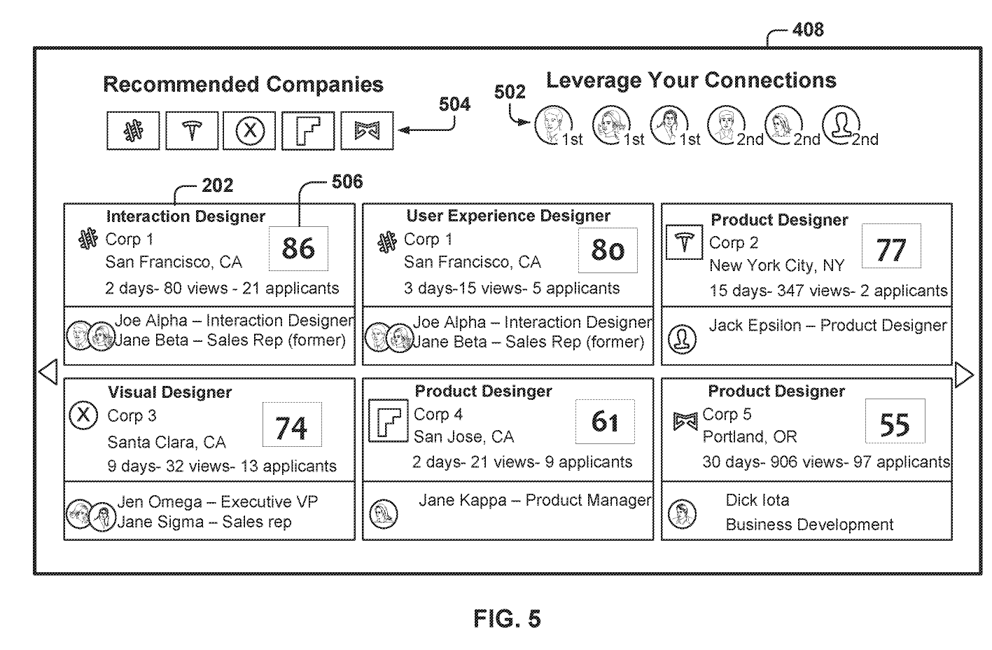

FIG. 5 is a detail of a connection-leverage group area 408 in the user interface, according to some example embodiments. In one example embodiment, the connection-leverage group area 408 includes recommendations of jobs that are offered by companies having employees that are socially connected with the member. The group area 408 lists companies 504 where the member 160 can likely leverage one or more connected members to use as references when applying for a job.

In some example embodiments, the information about the job includes the title of the job, the company offering the job, browsing data from other members (number of views, number of applicants), the location of the job, and other members in the first member's 160 social network who are currently or were formerly employed by the job.

In one example embodiment, the group area 408 includes profile pictures 502 of connected members, including primary connected members and secondary connected members that currently work, or previously worked, for the company. These connected members may be useful because the member 160 may be able to get into contact with these connected members in order to pursue a job within the company. In one embodiment, the group area 408 further includes profile pictures 502 within the recommendations of jobs 202 of people who are current or former employees of companies 504 offering the job recommendations. These pictures may display additional data such as the job title for the current or former employees. Additionally, the jobs 202 each include a company culture score display 506 representing the anticipated cultural fit of the member 160 with the job 202.

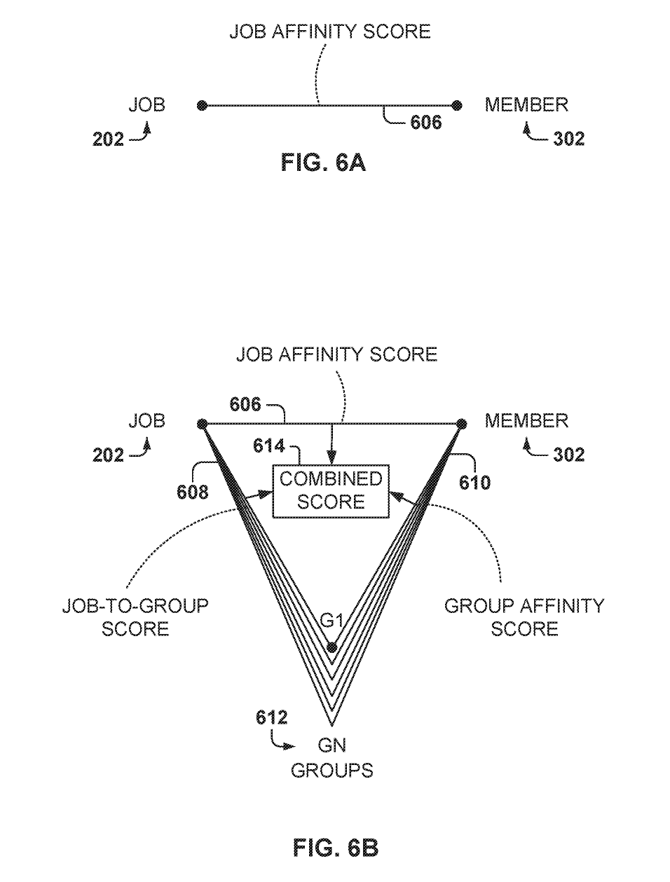

FIGS. 6A-6B illustrate the scoring of a job for a member, according to some example embodiments. FIG. 6A illustrates the scoring, also referred to herein as ranking, of a job 202 for a member associated with a member profile 302 based on a job affinity score 606.

The job affinity score 606, between a job 202 and a member profile 302, is a value that measures how well the job 202 matches the interest of the member in finding the job 202. A so-called “dream job” for a member would be the perfect job for the member and would have a high, or even maximum, value, while a job that the member is not interested in at all (e.g., in a different professional industry) would have a low job affinity score 606. In some example embodiments, the job affinity score 606 is a value between zero and one, or a value between zero and 100, although other ranges are possible.

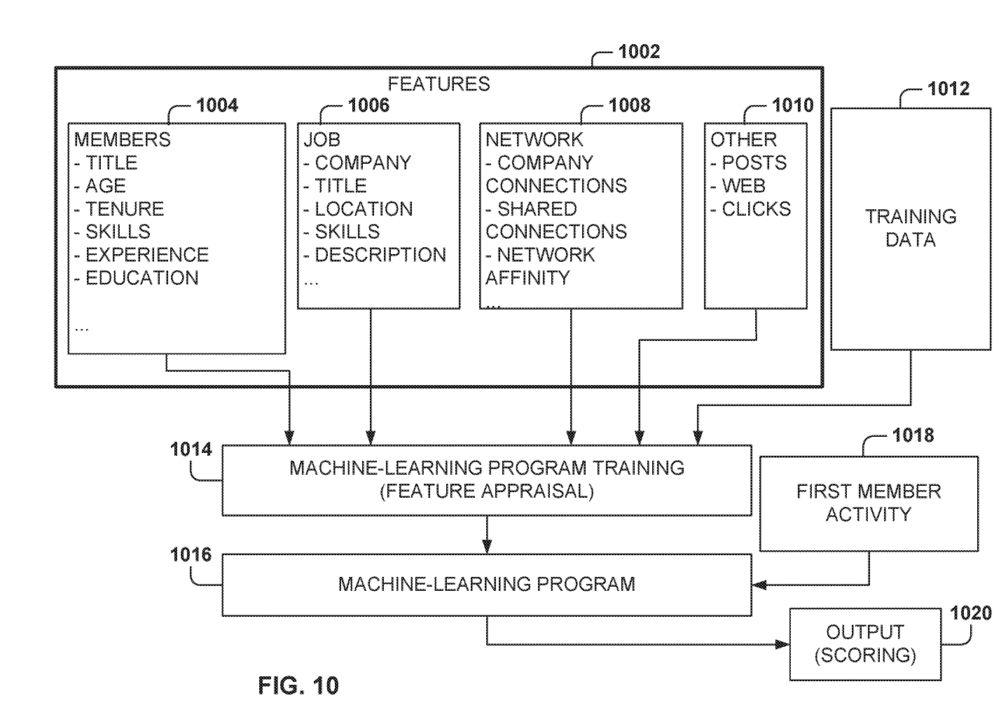

In some example embodiments, a machine-learning program is used to calculate the job affinity scores 606 for the jobs 202 available to the member. The machine-learning program is trained with existing data in the social network, and the machine-learning program is then used to evaluate jobs 202 based on the features used by the machine-learning program. In some example embodiments, the features include any combination of job data (e.g., job title, job description, company, geographic location, etc.), member profile data, member search history, employment of connected members of the member, job popularity in the social network, number of days the job has been posted, company reputation, company size, company age, profit vs. nonprofit company, and pay scale. More details are provided below with reference to FIG. 10 regarding the training and use of the machine-learning program.

FIG. 6B illustrates the scoring of a job 202 for a member associated with the member profile 302, according to some example embodiments, based on three parameters: the job affinity score 606, a job-to-group score 608, and a group affinity score 610. Broadly speaking, the job affinity score 606 indicates how relevant the job 202 is to the member, the job-to-group score 608 indicates how relevant the job 202 is to a group 612, and the group affinity score 610 indicates how relevant the group 612 is to the member. In the disclosed embodiments of the invention, the job-to-group score 608 a leverage score that acts as a measure for how well the member 160 is positioned to leverage connections on the social network to improve the member's chances to attain the job. Leveraging, as used herein, includes contacting connected members for a recommendation for the job (such as by the connected member contacting a hiring manager within the company and recommending the member 160), inquiring about best practices for applying and interviewing for the job, etc.

The group affinity score 610 indicates how relevant the group 612 is to the member, where a high affinity score indicates that the group 612 is very relevant to the member and should be presented in the user interface 402, while a low affinity score indicates that the group 612 is not relevant to the member and may be omitted from presentation in the user interface.

The group affinity score 610 is used, in some example embodiments, to determine which groups 612 are presented in the user interface 402, as discussed above, and the group affinity score 610 is also used to order the groups 612 when presenting them in the user interface, such that the groups 612 may be presented in the order of their respective group affinity scores 610. It is to be noted that if there is not enough “liquidity” of jobs for a group 612 (e.g., there are not enough jobs for presentation in the group 612), the group 612 may be omitted from the user interface 402 or presented with lower priority, even if the group affinity score 610 is high.

In some example embodiments, a machine-learning program is utilized for calculating the group affinity score 610. The machine-learning program is trained with member data, including interactions of users with the different groups 612. The data for the particular member is then utilized by the machine-learning program to determine the group affinity score 610 for the member with respect to a particular group 612. The features utilized by the machine-learning program include the history of interaction of the member with jobs from the group 612, click data for the member (e.g., a click rate based on how many times the member has interacted with the group 612), member interactions with other members who have a relationship to the group 612, and the like. For example, one feature may include an attribute that indicates whether the member is a student. If the member is a student, features such as connected members or education-related attributes will be important to determine which groups are of interest to the student. On the other hand, a member who has been out of school for 20 years or more may not be as interested in education-related features.

Another feature of interest to determine relevant connected members to leverage is whether any of the member's 160 primary or secondary connected members work for the company and the level to which these connected members are exploitable by the member 160 in order to attain the job.

Primary connected members are those members that are directly connected to the member 160 based on the bilateral agreement between members to be connections, and secondary connected members are those members that do not have a bilateral agreement to be connections with the member 160, but do have a bilateral agreement to be connections with a primary connected member.

In an example embodiment, the system assesses various connected members, including primary connected members of the member 160 that work for a company as well as primary connected members that are connected with a secondary connected member that is employed at the company. A machine learning tool assigns a connection strength to each of these connections between the member 160 and a connected member based on the type of connection (primary or secondary), social activity by the member 160 and the connected member (i.e., browsing data by the member 160 and by the connected member) and interactions between the member 160 and the connected member (such as exchanging messages or sharing items over the social network). In some embodiments, the machine learning algorithm determines the strength of connections based on identified features, such as distance between members (e.g., type of connected member), mails exchanged, education background of the members (e.g., went to same university), data from the member profile (e.g., both members were born in the same city, both members worked at the same company at some point in time), shared hobbies, job title, skill sets, age, etc.

The job-to-group score 608 between a job 202 and a group 612 indicates the job 202's strength within the context of the group 612, where a high job-to-group score 608 indicates that the job 202 is a good candidate for presentation within the group 612 and a low job-to-group score 608 indicates that the job 202 is not a good candidate for presentation within the group 612. In some example embodiments, a predetermined threshold is identified, wherein jobs 202 with a job-to-group score 608 equal to or above the predetermined threshold are included in the group 612, and jobs 202 with a job-to-group score 608 below the predetermined threshold are not included in the group 612.

Within a connection-leverage group, the job-to-group score 608 is referred to as the leverage score and measures a level of relevance the job has to the connection-leverage group. In an example embodiment, this level of relevance is derived by ranking the leverage scores for each job, as discussed below. For example, in a group 612 that presents jobs within the social network of the member, if there is a job 202 for a company within the network of the first member, the job-to-group score 608 indicates that the member 160 can leverage his or her network in order to reach the company of the job 202. Thus, the job-to-group score 608 provides an indication of how important it is to present the job to the user within the connection-leverage group. This is useful because the member 160 may be uniquely poised to fill a particular job based on the people he or she knows that work or have worked for the company (company connected members). Further, if the member 160 interacts with a company connected member often, or has another relationship aside from the connection (i.e., being a current coworker or both being alumni from a university), the member 160 will likely benefit from having the job presented as one of the first jobs within the connection-leverage group area 408.

In some example embodiments, the job affinity score 606, the job-to-group score 608, and the group affinity score 610 are combined to obtain a combined affinity score 614 for the job 202. The scores may be combined utilizing addition, weighted averaging, or other mathematical operations.

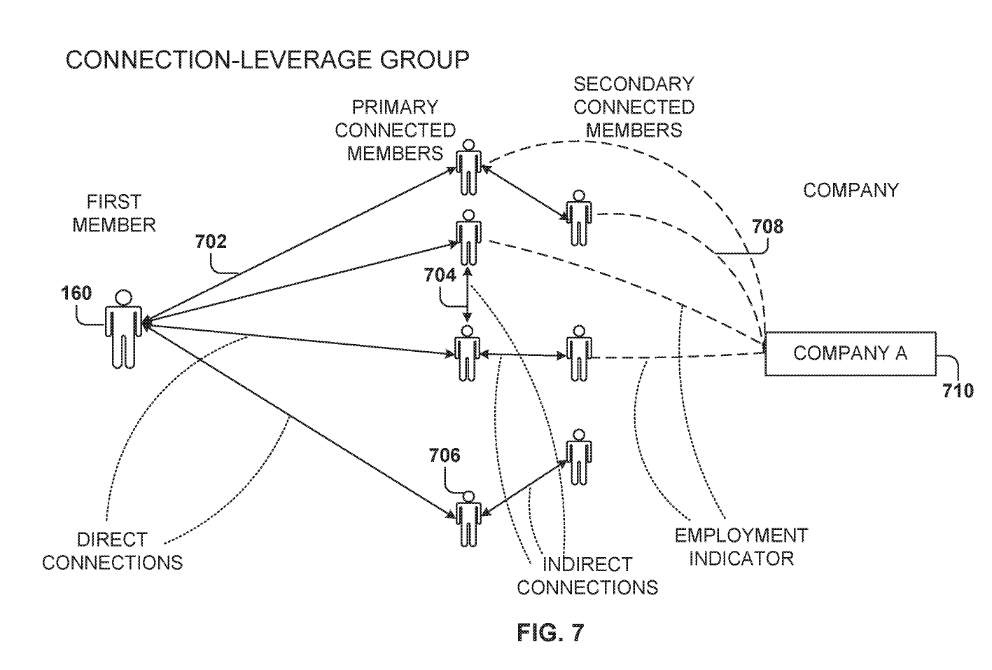

FIG. 7 shows the scoring of the company based on anticipated ability of the member 160 to leverage connections based on an employment status of the member's connections. Direct connections 702 are established between the member 160 and each of the primary connected members. Additionally, indirect connections are established based on a primary connected member's direct connection to a second member 706 that works for the company. This second member 706 is thus a secondary connected member because the member 160 and the second member 706 are connected over one “hop,” the hop being the primary connected member. Two primary connected members may also be socially connected as shown by connection 704.

The system determines a connection strength for each of the direct connections 702 and each of the indirect connections 704. In some embodiments, the connection strength is a score calculated based on various features about the connection. For example, the system may determine the connection strength based on whether the connection is a direct or an indirect connection. Additionally, the system can further use a machine-learning tool to determine a level of activity by the member 160 related to the connection and further base the score on this level of activity. For example, if browsing data indicates that the member 160 communicates frequently on the social network with a primary connected member, this can cause a higher connection strength for the direct connection 702 between the two members than if the member 160 rarely communicates with the primary connected member. In some embodiments, a member may have a higher connection strength with a primary connected member if the primary connected member is also connected with other primary connected members of the member.

In some embodiments, a primary connected member may have a job title that a machine learning tool has determined as being similar to the job title of the member. For example, the primary connected member may have the same job title as the member 160, and the connection strength will be increased because of the titles being equal. Additionally, the job that is offered may be the same or a similar one that the first primary connected member currently possesses, or the primary connected member may be in an influential position (i.e., Executive VP) such that the primary connected member can influence hiring decisions.

Additionally, the system determines which connected members are company connected members, represented in FIG. 7 by an employment indicator 708 that shows that some of the connected members are employed, or were previously employed, at Company A 710. In some example embodiments, as discussed below, the connection strengths from the company connected members are used to calculate the leverage score for a job, the leverage score representing a likelihood that an individual can leverage connections on the social network to attain a job.

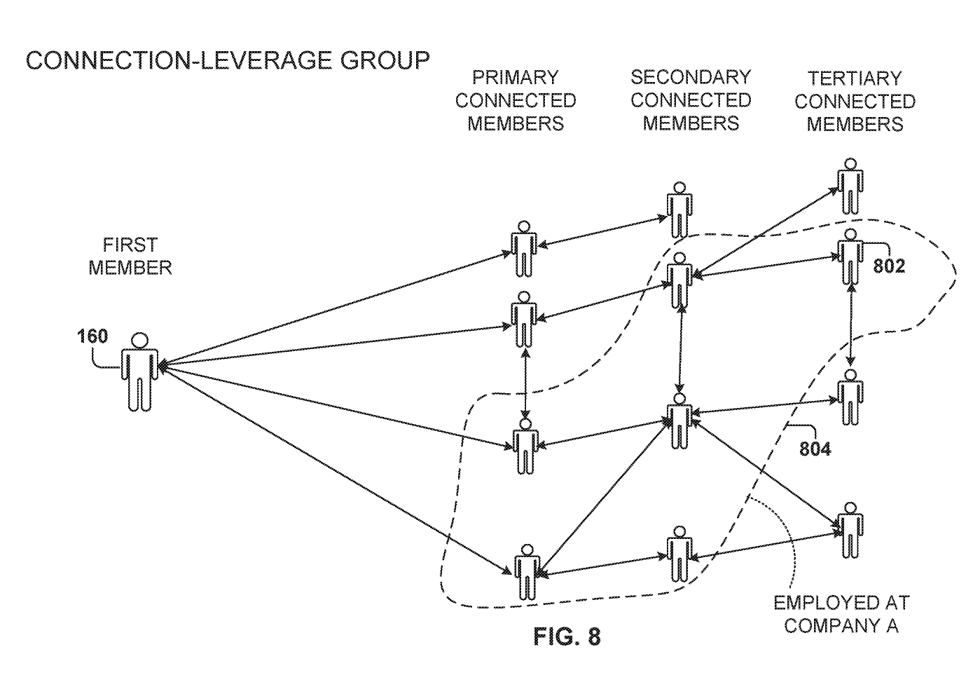

FIG. 8 illustrates a network map of connections to a member 160 and discloses a representation of the scoring based on the anticipated ability of the member 160 to leverage his or her connections in order to attain a job offered by a company. Additionally, shown in FIG. 8 are tertiary connected members 802, which are directly connected to at least one secondary connected member but are not connected to primary connected members or the member 160. Thus, a tertiary connected member 802 is two “hops” away from the member 160: one hop for the directly connected secondary connected member and one hop for the primary connected member that is directly connected to the secondary connected member.

Also shown within FIG. 8 is a company area 804 that indicates which connected members are company connected members, the company connected members being connected members of the member 160 that currently are employed by the company offering the job or that were formerly employed by the company offering the job. As shown, some primary connected members are not company connected members; thus, the connection strength of the connections between the member 160 and these primary connected members would not be used to calculate the leverage score. However, a primary connected member may be directly connected to a secondary connected member that is a company connected member, in which case the connection strength between member 160 and the primary connected member is used in calculating the connection strength of the secondary member.

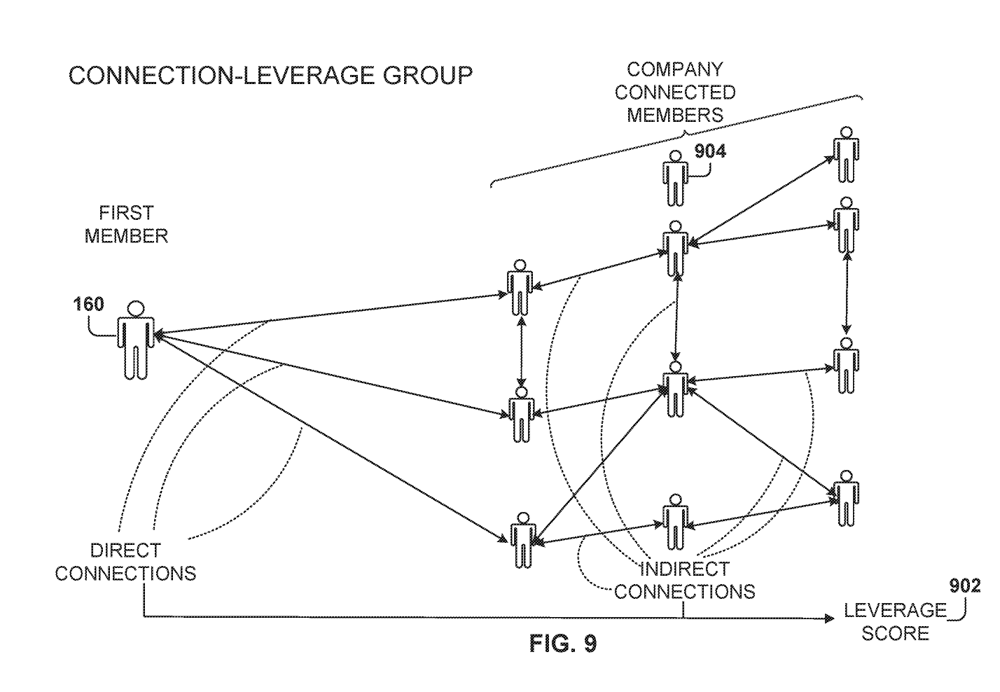

FIG. 9 depicts a network map and details how various company connected members are used to determine a leverage score 902. In FIG. 9, only members that are company connected members are shown.

A secondary connected member 904 does not have any direct connections to the member 160 or to other company connected members shown on this illustration because the secondary connected member 904 is directly connected (connection strength A) with a primary connected member that is connected to the member 160 (connection strength B), but is not a company connected member, and thus excluded from the illustration. Taking the secondary connected member 904 as an example, a connection strength between the member 160 and the secondary connected member 904 is based on several factors including: a connection strength from the member 160 to the primary connected member (connection strength 13) and a connection strength from the primary connected member to the secondary connected member (connection strength The first connection strength will be based on connections A and B as well as in the distance between the member and the secondary connected member 904.

Additionally, each of the connected members (primary, secondary, tertiary, etc.) has an affinity with the company, which is referred to as the connection value k. A primary connection strength (k-PCS₁, k-PCS₂) of a first connection member is the connection strength of a direct connection between the first connection member and company connected members. A secondary connection strength (k-SCS₁, k-SCS₂) of a first connection member is the connection strength of a secondary connection between the first connection member and a company connected member. Similarly a tertiary connection strength (k-TCS₁, k-TCS₂) of a first connection member is the connection strength of a tertiary connection between the first connection member and a company connected member.

Using summation of the primary connections strengths (k-PCS), secondary connection strengths (k-SCS), and tertiary connection strengths (k-TCS), the system determines the connection value k of a first connected member based on the PCS of direct connections, company connected members that the first connected member is secondarily connected to (secondary connection strength, SCS), and company connected members that the first connection is a tertiary connection of. In one example embodiment, the equation to calculate the a connection value kᵢ of member i (member i being a connected member of the searching member 160) to a company is as follows:

kᵢ=Σ(k-PCS·β1, k-SCS·β2, k-TCS·β3)

Where:

k-PCS=k-PCS₁+k-PCS₂+ . . . +k-PCSₙ

k-SCS=k-SCS₁+k-SCS₂+ . . . +k-SCSₘ

k-TCS=k-TCS₁+k-TCS₂+ . . . +k-TCSⱼ

β1>β2>β3

In the above equation, k-PCS is the summation of all primary connected members' strengths. Each of the primary connected member strengths (k-PCS₁, k-PCS₂, etc.) are determined by a machine learning tool. Similarly, k-SCS and k-PCS are summations of the secondary connections strengths and the tertiary connected member strengths, respectively. Additionally, there are distance coefficients β1, β2, and β3 that dampen the secondary and tertiary connected member strength summations compared to the primary connected member strength summation. In an example where β1 equals 0.75, β2 is a smaller number, such as 0.143, and β3 is an even smaller number, such as 0.023, in order to dampen the effect of the secondary and tertiary connections on kᵢ. Other embodiments may have other coefficient values.

In order to find the leverage score (LS) of the member 160 (M1) to a first company (C1), the connection values (kᵢ, kⱼ, kₗ, . . . ) of the member 160 are calculated as shown above and used in the following equation.

LS(M1, C1)=α₁(H_{X}kᵢ)+α₂(H_{X}kₗ)+ . . . +αₙ(H_{X}kₙ)

In the above equation, Hₓ is a constant coefficient based on the distance (number of “hops”) the connection is from the member 160. In some example embodiments, these coefficients are accessed within the connection database 134. For example, H₁ would be the coefficient applied if the connection associated with kᵢ is a primary connected member, since there is only one “hop” from the member 160 to the connection. Similarly, H₂ would be the coefficient applied if the connection associated with k is a secondary connection, and so on.

Additionally, a similarity coefficient (α) is applied to each connection value. The similarity coefficient is determined by a machine-learning program, as shown in FIG. 10, and is a real number that quantifies a similarity between skills of the first member and skills of a connected member. The similarity coefficient is also referred to herein as the similarity value. In some example embodiments, the similarity coefficient is in the range 0 to 1, but other ranges are also possible. In some embodiments, cosine similarity is utilized to calculate the similarity coefficient between the skills.

FIG. 10 illustrates the training and use of the machine-learning program 1016, according to some example embodiments. In some example embodiments, machine-learning programs, also referred to as machine-learning algorithms or tools, are utilized to perform operations associated with job searches.

Machine learning is a field of study that gives computers the ability to learn without being explicitly programmed. Machine learning explores the study and construction of algorithms, also referred to herein as tools that may learn from existing data and make predictions about new data. Such machine-learning tools operate by building a model from example training data 1012 in order to make data-driven predictions or decisions expressed as outputs or assessments (e.g., a score) 1120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

In general, there are two types of problems in machine learning: classification problems and regression problems. Classification problems aim at classifying items into one of several categories (for example, is this object an apple or an orange?). Regression algorithms aim at quantifying some items (for example, by providing a value that is a real number). In some embodiments, example machine-learning algorithms provide a job affinity score 606 (e.g., a number from 1 to 100) to qualify each job as a match for the user (e.g., calculating the job affinity score 606). In other example embodiments, machine learning is also utilized to calculate the group affinity score 610 and the job-to-group score 608. The machine-learning algorithms utilize the training data 1012 to find correlations among identified features 1002 that affect the outcome.

in one example embodiment, the features 1002 may be of different types and may include one or more of member features 1004, job features 1006, network features 1008, and other features 1010. The member features 1004 may include one or more of the data in the member profile 302, as described in FIG. 3, such as title, skills, experience, education, and so forth. The job features 1006 may include any data related to the job 202, and the network features 1008 may include various data related to connections (and connection strengths) within the social network. In some example embodiments, additional features in the other features 1010 may be included, such as post data, message data, web data, click data, and so forth.

With the training data 1012 and the identified features 1002, the machine-learning tool is trained at operation 1012 The machine-learning tool appraises the value of the features 1002 as they correlate to the training data 1012. The result of the training is the trained machine-learning program 1016.

When the machine-learning program 1016 is used to generate a score, new data, such as first member activity 1018, is provided as an input to the trained machine-learning program 1016, and the machine-learning program 1016 generates the score 1020 as output. For example, when a member performs a job search, a machine-learning program, such as the machine-learning program 1016, trained with social network data, uses the member data and job data from the jobs in the job database 128 to search for jobs that match the member's profile 302 and activity.

As discussed above, the machine-learning program 1016 may be used to determine the strengths of direct connections between members of the social network based on actions of the members, actions of other members, position title of the members, and various additional features 1002 located in 1004, 1006, 1008, and 1010. In an example embodiment, proxy employees are determined based on member features 1004.

In an example, the system determines a first skill set for the member 160 based on the skills within the member profile 302 of the member 160. Proxy members, in this example, are other members within the social network that share skills within this first skill set. The system further provides a plurality of survey questions to the proxy members. The answers from theses survey questions can further be used as member features 1004 with which to train the machine-learning program 1016 and determine various connections strengths related to the member 160.

For example, proxy members may overwhelmingly reply to a survey that they are closest with connections on the social network that they attended undergraduate college with. Based on this data, the machine-learning program 1016 determines higher connection strengths between members that share an undergraduate institution with the same years in their respective member profiles.

In some embodiments, the machine-learning program 1016 accesses various data from the first member activity 1118 for us in further determining a weight for company connected members based on the first member's 160 interactions with the company. For example, when the machine-learning program 1016 aggregates member interactions in which the member 160 displays a high rate of growth in direct connections to company connected members (i.e. the first member is making more connections to current or former employees), the machine-learning program 1016 may add a weighting factor to increase the connected member strength of company connected members for the member 160. In some embodiments, the program 1016 may further apply a weighting factor to the connection strengths of the connected members based on how recently (i.e., a number of days) the last activity, such as a browsing action, of the member 160 to a company connected member occurred. In some embodiments, the program 1016 may further weight the company connected members based on the member 160 having a high job affinity score 606 for jobs within the company.

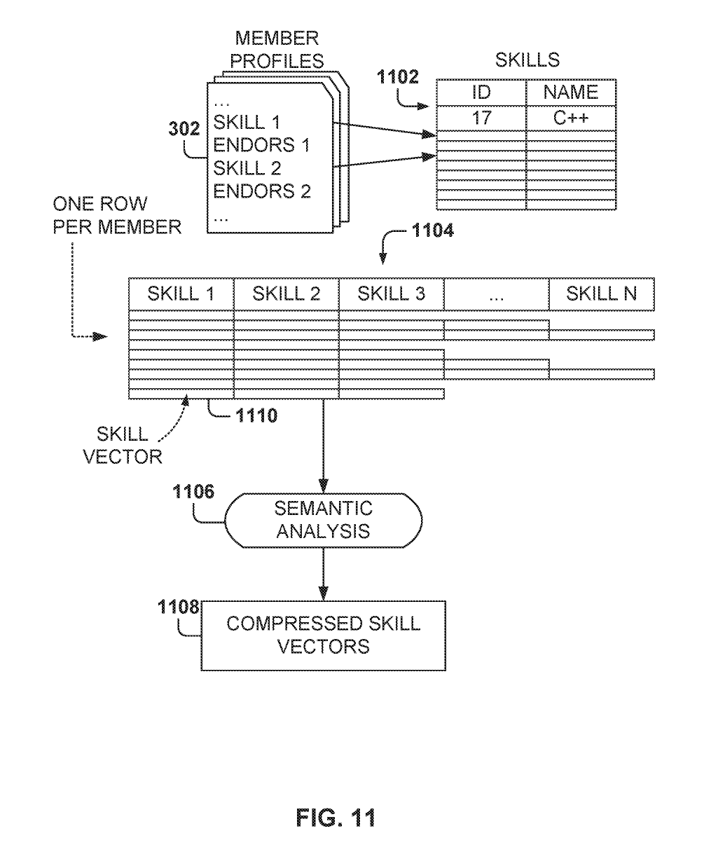

FIG. 11 illustrates a method for identifying similarities among member skills, such as by the machine-learning program 1016 according to some example embodiments. In some example embodiments, the system compares skills from the first member's skill set to skills of connected members in order to determine In some example embodiments, the skills of the members of the social network are represented within a vector in a small dimensional space (e.g., with a dimension of 200). The vectors of the employees of the company are compared to the vector of the member searching for the job, and the employees that have similar vectors are identified as members of the virtual team.

Some example embodiments are presented for comparing member skills, but the same principles may be applied by comparing other features in addition to the skills, such as title, position, function within the company, years of experience, etc., or any combination thereof. In some example embodiments, semantic vectors are created for the skills of members, and in other embodiments, the semantic vectors include the skills, the title, and the job function, for example.

Reducing vector dimension from a sparse vector representation to a compressed vector representation may be done in several ways. In one embodiment, the skills and title of each member are placed within a row, and then matrix factorization is utilized to reduce the vectors to a smaller dimension, such as 50 or 100. Then, on the reduced-dimension pace, a nearest neighbor computation from the member is performed, restricted to the employees of the company of interest, resulting in a similarity coefficient for each employee. This way, the members with similar skills are found. Afterwards, the top members with the best similarity coefficients are selected for the virtual team. For example, the mutual team may include the top four members, or the top six members, or the top 50 members, etc

In some example embodiments, a similarity threshold is defined, and people are selected for the virtual team when their similarity coefficient with reference to the member is above the similarity threshold. Therefore, there could be the case where there is no virtual team for the member in the company posting the job.

Semantic analysis finds similarities among member skills by creating a vector for each member such that members with similar skills have skill vectors 1008 near each other. In one example embodiment, the tool Word2vec is used to perform the semantic analysis, but other tools may also be used, such as Gensim, Latent Dirichlet Allocation (LDA), or Tensor flow.

These models are shallow, two-layer neural networks that are trained to reconstruct linguistic contexts of words. Word2vec takes as input a large corpus of text and produces a high-dimensional space (typically between a hundred and several hundred dimensions). Each unique word in the corpus is assigned a corresponding vector in the space. The vectors are positioned in the vector space such that words that share common contexts in the corpus are located in close proximity to one another in the space. In one example embodiment, each element of the skill vector 1108 is a real number.

Initially, a simple skill vector 1110 is created for each skill, where each simple skill vector 1110 includes a plurality of zeros and a 1 at the location corresponding to the skill. Afterwards, a concatenated skill table 1102 included in the member features 1104 is created, where each row includes a sequence with all the skills for a corresponding member. Thus, the first row of concatenated skill table 1104 includes all the simple skill vectors 1110 for the skills of the first member, the second row includes all the simple skill vectors 1110 for the skills of the second member, and so forth.

A semantic analysis operation 1106 is then performed on the concatenated skill table 1104. In one example embodiment, Word2vec is utilized, and the result is compressed skill vectors 1108, or simply referred to as “skill vectors,” such that members with similar skills have skill vectors 1108 near each other (e.g., with a similarity coefficient below a predetermined threshold).

Using these models, the system can determine a similarity value for a connection between two members on the social network. In some embodiments, similarity values are used to further calculate connection strengths between the two members. In an example, the similarity value between a primary connected member and a secondary connected member is determined by the machine-learning program 1016 to be 0.5678 on a scale of 0 to 1. In this example, this correlates to a connection strength between the primary connected member and the secondary connected member of 57 on a scale of 1-100.

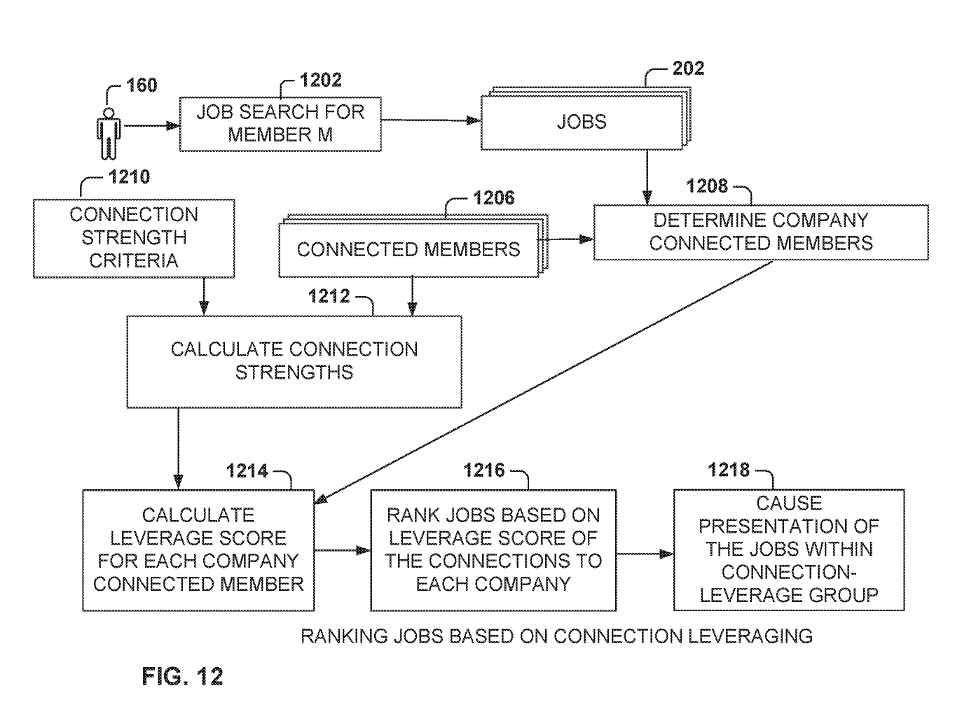

FIG. 12 is an additional illustration of a method for assigning a leveraging score in response to a search for a member in some example embodiments. A search for jobs is performed (at operation 1202) for a member, such as the member 160. The search may be initiated by the member 160, such as by navigating to a “leverage your connections” page on a user interface, or may be initiated by the system to suggest jobs to the member. The system then accesses jobs 202 available for presentation to the member and determines which of the connected members 1206 (primary, secondary, etc.) of the user have worked for one or more of the companies offering the job 202. At operation 1208, the system accesses a plurality of jobs 202, such as from the job database 128, to determine which company is offering each job 1204.

At operation 1212, the system calculates connection strengths based on information about the connected members 1206 and various criteria 1210 about calculating connection strengths. As discussed above, the machine learning program 1102 is employed, in some embodiments, to determine the connection strengths between directly connected members based on the connection strength criteria 1210. Also, as shown in an equation above, connection strengths between the member 160 and secondary connected members can be determined using connection strengths with the shared primary connected member strengths and normalized using a hop coefficient for the “hop.” In some embodiments, the hop coefficient is used to decrease the value of the connection strength as the distance to the member increases. The connection leverage score 902 is determined at operation 1214 using a summation equation as shown above.

At operation 1216, the system ranks the jobs 202 based on the connection leverage score 902 of the company offering the job. In operation 1212, the system causes the presentation of the jobs 202 to the member 160 within the connection-leverage group area 408 based on the ranking. For example, a first job with a higher connection leverage score 902 than a second job will be ranked ahead of the second job. Then, at operation 1218, when the system presents the jobs 202 within the connection-leverage group area 408, the first job will be presented with more prominence than the second job within the connection-leverage group area 408.

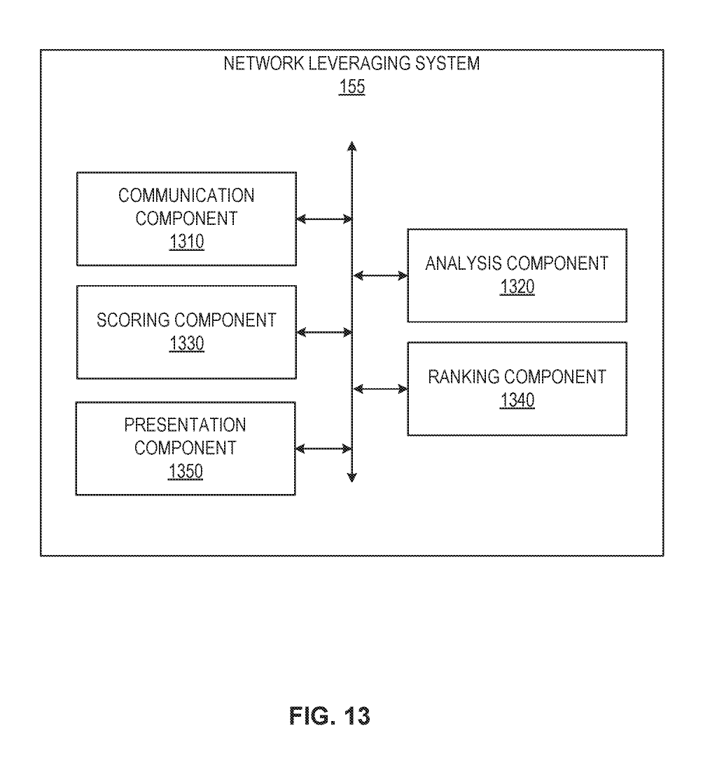

FIG. 13 illustrates the network-leveraging system 155 for implementing example embodiments. In one example embodiment, network-leveraging system 155 includes a communication component 1310, an analysis component 1320, a scoring component 1330, a ranking component 1340, and a presentation component 1350.

The communication component 1310 provides various data retrieval and communications functionality. In example embodiments, the communication component 1310 retrieves data from the databases 132, 128, 130, and 134 including member data, jobs, group data, network features 1008, job features 1006, and member features 1004. The communication component 1310 can further retrieve data from the databases 132, 128, 130, and 134 related to rules for determining connection strengths.

The analysis component 1320 performs operations such as determining connection strengths between members on the social network. Additionally, the analysis component 1320 may perform machine-learning programs 1016 described in FIG. 11 to determine connection strengths between directly connected members. In some embodiments, the analysis component 1320 further compares groups, e.g., groups 712, to determine one or more groups for presentation of a job and also a presenting group for the job.

The scoring component 1330 calculates the scores described in FIG. 7B, as well as a connection leverage score 902 for a job offered by a company on the job application 152, the connection leverage score 902 describing the anticipated ability of a member 160 to leverage his or her connections within the social network to attain a job.

The ranking component 1340 provides functionality to rank jobs by the connection leverage score 902, as determined by the scoring component 1330, within the connection-leverage group area 408. In some example embodiments, the jobs are ranked from highest leverage score 902 to lowest leverage score 902. In alternative embodiments, jobs may be ranked based on an average connection leverage score 902 of the company offering the job.

The presentation component 1350 provides functionality to present a display of the connection-leverage group area 408 including the jobs with a display of the leverage score 902 to the member 160, such as on the user interface 402.

It is to be noted that the embodiments illustrated in FIG. 13 are examples and do not describe every possible embodiment. Other embodiments may utilize different servers or additional servers, combine the functionality of two or more servers into a single server, utilize a distributed server pool, and so forth. The embodiments illustrated in FIG. 13 should therefore not be interpreted to be exclusive or limiting, but rather illustrative.

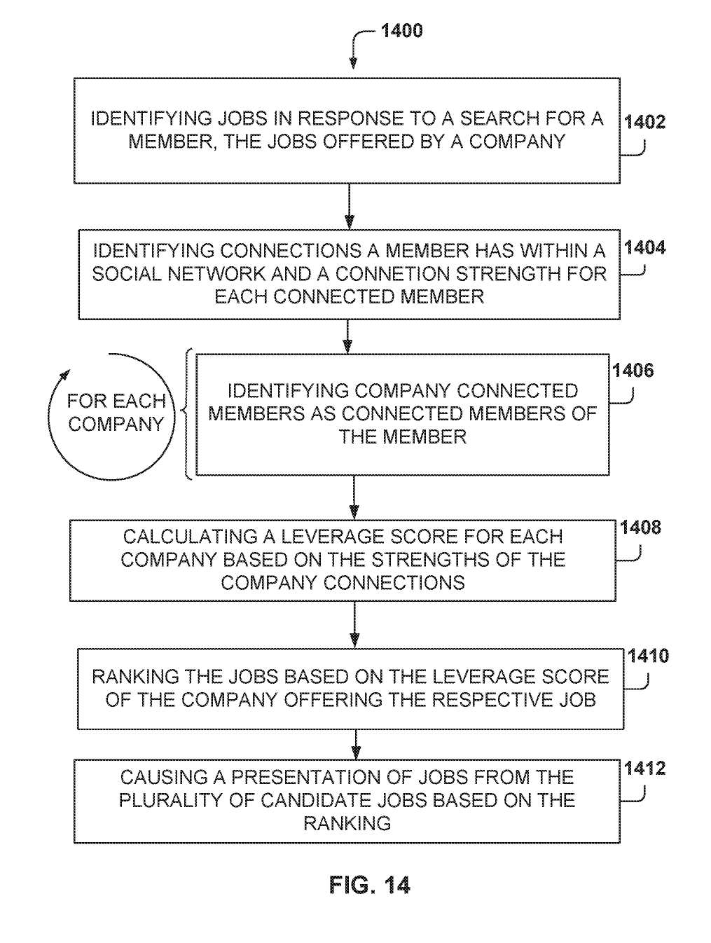

FIG. 14 is a flowchart of a method 1400, according to some example embodiments, for selecting jobs for a user based on the connections of the user in a social network. While the various operations in this flowchart are presented and described sequentially, one of ordinary skill will appreciate that some or all of the operations may be executed in a different order, be combined or omitted, or be executed in parallel.

Operation 1402 is for identifying, by a server having one or more processors, jobs for presentation to a member 160 in response to a job search for (i.e. a search by the first member or on behalf of the first member) the member 160. From operation 1402, the method 1400 flows to operation 1404, where the server identifies, such as by the analysis component 1320 using the machine learning program 1102, connected members that the member 160 has within the social network and a connection strength for each of the connected members. From operation 1404, the method 1400 flows to operation 1406, where, for each company offering at least one job in the plurality, the server identifies one or more company connected members as connections of the member 160 that currently work for the company or previously have worked for the company. From operation 1406, the method 1400 flows to operation 1408, where the server calculates a connection leverage score 902 for each company based on the strengths of the company connected members (such as by averaging the strengths). The method 1400 then flows to operation 1410 where the jobs are ranked by the server based on the connection leverage score 902 associated with the company offering the respective job. Finally, the method 1400 flows to operation 1412, where the system causes presentation of the jobs within the connection-leverage group area 408 based on the ranking of the jobs based on the connection leverage score 902.

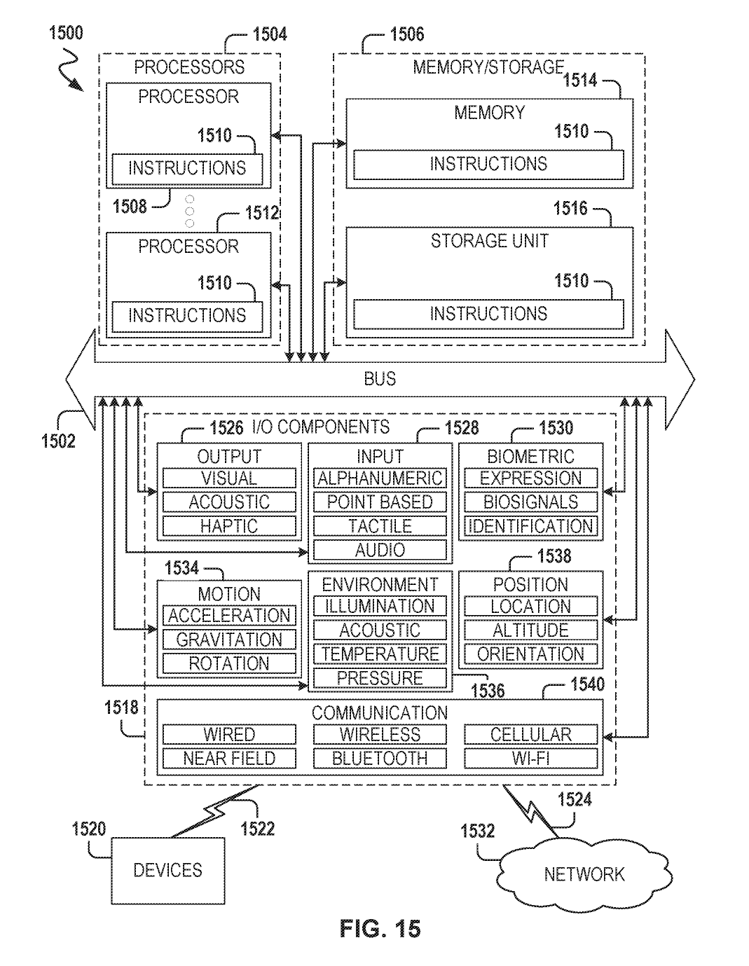

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1510 (e.g., software, a program, an application, an applet, an app, or other executable code) for causing the machine 1500 to perform any one or more of the methodologies discussed herein may be executed. For example, the instructions 1510 may cause the machine 1500 to execute the flow diagram of FIG. 14. Additionally, or alternatively, the instructions 1510 may implement the job-scoring programs and the machine-learning programs associated with them. The instructions 1510 transform the general, non-programmed machine 1500 into a particular machine 1500 programmed to carry out the described and illustrated functions in the manner described.

In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1510, sequentially or otherwise, that specify actions to be taken by the machine 1500. Further, while only a single machine 1500 is illustrated, the term “machine” shall also be taken to include a collection of machines 1500 that individually or jointly execute the instructions 1510 to perform any one or more of the methodologies discussed herein.

The machine 1500 may include processors 1504, memory/storage 1506, and I/O components 1518, which may be configured to communicate with each other such as via a bus 1502. In an example embodiment, the processors 1504 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1508 and a processor 1512 that may execute the instructions 1510. The term “processor” is intended to include multi-core processors that may comprise two or more independent processors (sometimes referred to as “cores”) that may execute instructions 1510 contemporaneously. Although FIG. 15 shows multiple processors 1504, the machine 1500 may include a single processor with a single core, a single processor with multiple cores (e.g., a multi-core processor), multiple processors with a single core, multiple processors with multiples cores, or any combination thereof.

The memory/storage 1506 may include a memory 1514, such as a main memory, or other memory storage, and a storage unit 1516, both accessible to the processors 1504 such as via the bus 1502. The storage unit 1516 and memory 1514 store the instructions 1510 embodying any one or more of the methodologies or functions described herein. The instructions 1510 may also reside, completely or partially, within the memory 1514, within the storage unit 1516, within at least one of the processors 1504 (e.g., within the processor's cache memory), or any suitable combination thereof, during execution thereof by the machine 1500. Accordingly, the memory 1514, the storage unit 1516, and the memory of the processors 1504 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1510. The term “machine-readable medium” shall also be taken to include any medium, or combination of multiple media, that is capable of storing instructions (e.g., instructions 1510) for execution by a machine (e.g., machine 1500), such that the instructions, when executed by one or more processors of the machine (e.g., processors 1504), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1518 may include a wide variety of components to receive input, provide output, produce output, transmit information, exchange information, capture measurements, and so on. The specific 1/0 components 1518 that are included in a particular machine will depend on the type of machine. For example, portable machines such as mobile phones will likely include a touch input device or other such input mechanisms, while a headless server machine will likely not include such a touch input device. It will be appreciated that the I/O components 1518 may include many other components that are not shown in FIG. 15. The I/O components 1518 are grouped according to functionality merely for simplifying the following discussion, and the grouping is in no way limiting. In various example embodiments, the I/O components 1518 may include output components 1526 and input components 1528. The output components 1526 may include visual components (e.g., a display such as a plasma display panel (PDP), a light emitting diode (LED) display, a liquid crystal display (LCD), a projector, or a cathode ray tube (CRT)), acoustic components speakers), haptic components (e.g., a vibratory motor, resistance mechanisms), other signal generators, and so forth. The input components 1528 may include alphanumeric input components (e.g., a keyboard, a touch screen configured to receive alphanumeric input, a photo-optical keyboard, or other alphanumeric input components), point-based input components a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1518 may include biometric components 1530, motion components 1534, environmental components 1536, or position components 1538 among a wide array of other components. For example, the biometric components 1530 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1534 may include acceleration sensor components (e.g., accelerometer), gravitation sensor components, rotation sensor components (e.g., gyroscope), and so forth. The environmental components 1536 may include, for example, illumination sensor components (e.g., photometer temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1538 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The 110 components 1518 may include communication components 1540 operable to couple the machine 1500 to a network 1532 or devices 1520 via a coupling 1524 and a coupling 1522, respectively. For example, the communication components 1540 may include a network interface component or other suitable device to interface with the network 1532. In further examples, the communication components 1540 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1520 may be another machine or any of a wide variety of peripheral devices (e.g., a peripheral device coupled via a USB).

Moreover, the communication components 1540 may detect identifiers or include components operable to detect identifiers. For example, the communication components 1540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1540, such as location via Internet Protocol (IP) geo-location, location via Wi-Fi® signal triangulation, location via detecting an NFC beacon signal that may indicate a particular location, and so forth.

In various example embodiments, one or more portions of the network 1532 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1532 or a portion of the network 1532 may include a wireless or cellular network and the coupling 1524 may be a Code Division Multiple Access (CDMA) connection, a Global System for Mobile communications (GSM) connection, or another type of cellular or wireless coupling. In this example, the coupling 1524 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1510 may be transmitted or received over the network 1532 using a transmission medium via a network interface device (e.g., a network interface component included in the communication components 1540) and utilizing any one of a number of well-known transfer protocols (e.g., hypertext transfer protocol (HTTP)). Similarly, the instructions 1510 may be transmitted or received using a transmission medium via the coupling 1522 (e.g., a peer-to-peer coupling) to the devices 1520. The term “transmission medium” shall be taken to include any intangible medium that is capable of storing, encoding, or carrying the instructions 1510 for execution by the machine 1500, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

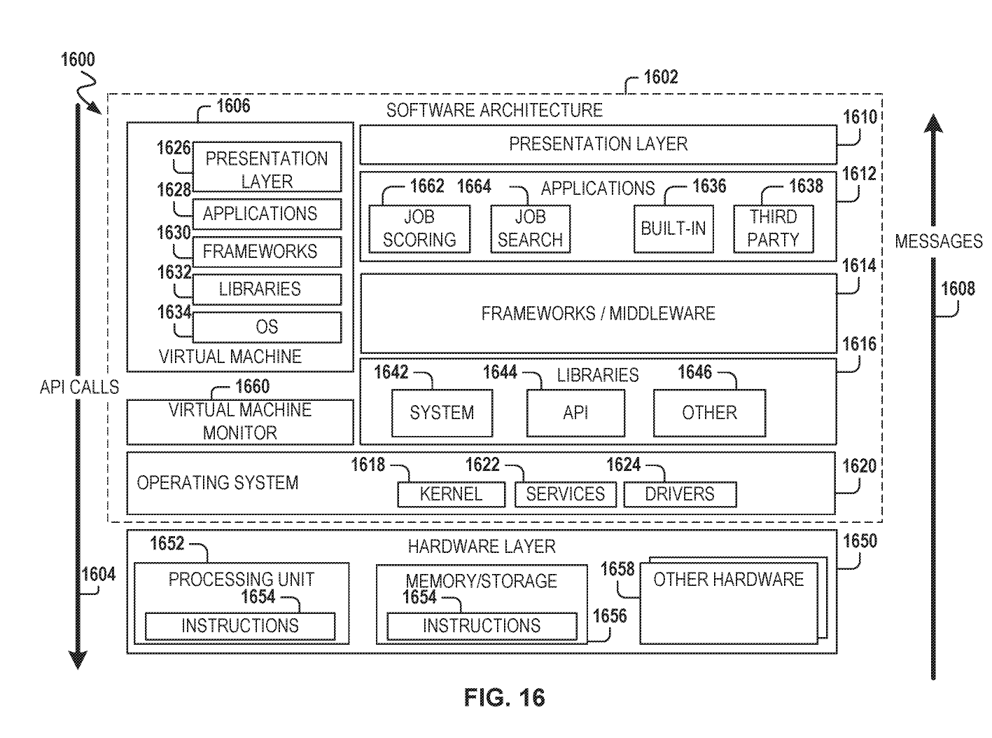

FIG. 16 is a block diagram 1600 illustrating a representative software architecture 1602, which may be used in conjunction with various hardware architectures herein described. FIG. 16 is merely a non-limiting example of a software architecture 1602, and it will be appreciated that many other architectures may be implemented to facilitate the functionality described herein. The software architecture 1602 may be executing on hardware such as a machine 1500 of FIG. 15 that includes, among other things, processors 1504, memory/storage 1506, and input/output (I/O) components 1518. A representative hardware layer 1650 is illustrated and can represent, for example, the machine 1500 of FIG. 15. The representative hardware layer 1650 comprises one or more processing units 1652 having associated executable instructions 1654. The executable instructions 1654 represent the executable instructions of the software architecture 1602, including implementation of the methods, modules, and so forth of the previous figures. The hardware layer 1650 also includes memory and/or storage modules 1656, which also have the executable instructions 1654. The hardware layer 1650 may also comprise other hardware 1658, which represents any other hardware of the hardware layer 1650, such as the other hardware illustrated as part of the machine 1500.

In the example architecture of FIG. 16, the software architecture 1602 may be conceptualized as a stack of layers where each layer provides particular functionality. For example, the software architecture 1602 may include layers such as an operating system 1620, libraries 1616, frameworks/middleware 1614, applications 1612, and a presentation layer 1610. Operationally, the applications 1612 and/or other components within the layers may invoke application programming interface (API) calls 1604 through the software stack and receive a response, returned values, and so forth illustrated as messages 1608 in response to the API calls 1604. The layers illustrated are representative in nature, and not all software architectures have all layers. For example, some mobile or special-purpose operating systems may not provide a frameworks/middleware layer 1614, while others may provide such a layer. Other software architectures may include additional or different layers.

The operating system 1620 may manage hardware resources and provide common services. The operating system 1620 may include, for example, a kernel 1618, services 1622, and drivers 1624. The kernel 1618 may act as an abstraction layer between the hardware and the other software layers. For example, the kernel 1618 may be responsible for memory management, processor management (e.g., scheduling), component management, networking, security settings, and so on. The services 1622 may provide other common services for the other software layers. The drivers 1624 may be responsible for controlling or interfacing with the underlying hardware. For instance, the drivers 1624 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1616 may provide a common infrastructure that may be utilized by the applications 1612 and/or other components and/or layers. The libraries 1616 typically provide functionality that allows other software modules to perform tasks in an easier fashion than by interfacing directly with the underlying operating system 1620 functionality (e.g., kernel 1618, services 1622, and/or drivers 1624). The libraries 1616 may include system libraries 1642 (e.g., C standard library) that may provide functions such as memory allocation functions, string manipulation functions, mathematic functions, and the like. In addition, the libraries 1616 may include API libraries 1644 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 1616 may also include a wide variety of other libraries 1646 to provide many other APIs to the applications 1612 and other software components/modules.

The frameworks 1614 (also sometimes referred to as middleware) may provide a higher-level common infrastructure that may be utilized by the applications 1612 and/or other software components/modules. For example, the frameworks 1614 may provide various graphic user interface (GUI) functions, high-level resource management, high-level location services, and so forth. The frameworks 1614 may provide a broad spectrum of other APIs that may be utilized by the applications 1612 and/or other software components/modules, some of which may be specific to a particular operating system or platform.

The applications 1612 include job-scoring applications 1662, job search/suggestions 1664, built-in applications 1636, and third-party applications 1638. The job-scoring applications 1662 comprise the job-scoring applications, as discussed above with reference to FIG. 11. Examples of representative built-in applications 1636 may include, but are not limited to, a contacts application, a browser application, a book reader application, a location application, a media application, a messaging application, and/or a game application. The third-party applications 1638 may include any of the built-in applications 1636 as well as a broad assortment of other applications. In a specific example, the third-party application 1638 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1638 may invoke the API calls 1604 provided by the mobile operating system such as the operating system 1620 to facilitate functionality described herein.

The applications 1612 may utilize built-in operating system functions (e.g., kernel 1618, services 1622, and/or drivers 1624), libraries (e.g., system libraries 1642, API libraries 1644, and other libraries 1646), or frameworks/middleware 1614 to create user interfaces to interact with users of the system. Alternatively, or additionally, in some systems, interactions with a user may occur through a presentation layer, such as the presentation layer 1610. In these systems, the application/module “logic” can be separated from the aspects of the application/module that interact with a user.

Some software architectures utilize virtual machines. In the example of FIG. 16, this is illustrated by a virtual machine 1606. A virtual machine creates a software environment where applications/modules can execute as if they were executing on a hardware machine (such as the machine 1600 of FIG. 16, for example). The virtual machine 1606 is hosted by a host operating system (e.g., operating system 1620 in FIG. 16) and typically, although not always, has a virtual machine monitor 1660, which manages the operation of the virtual machine 1606 as well as the interface with the host operating system (e.g., operating system 1620). A software architecture executes within the virtual machine 1606, such as an operating system 1634, libraries 1632, frameworks/middleware 1630, applications 1628, and/or a presentation layer 1626. These layers of software architecture executing within the virtual machine 1606 can be the same as corresponding layers previously described or may be different.

What is claimed is:

1. A method comprising:
identifying, by a server having at least one processor, a plurality of jobs in response to a search for jobs for a member, each job being offered by a company from a plurality of companies;
identifying connected members of the member in a social network, each connected member being associated with a connection strength;
for each company offering at least one of the jobs, identifying company connected members as the connected members of the member that are working for the company or that previously worked for the company; and
for each company, calculating a leverage score for the company based on the connection strengths of the company connected members;
ranking the plurality of jobs based on the leverage scores; and
causing a presentation of jobs from the plurality of jobs based on the ranking.

2. The method of claim 1, wherein the company connected members include a subset of primary company connected members and a subset of secondary company connected members, a primary company connected member being a member on the social network that is directly connected with the member on the social network, a secondary company connected member being a member on the social network that is not directly connected with the member and is directly connected with at least one of the primary connected members of the member.

3. The method of claim 2, wherein the leverage score for the company is calculated based on the connection strengths of the subset of primary company connected members.

4. The method of claim 3, wherein the connection strength of a company primary connected member is calculated based on the company primary connected member having also connected with another company primary connected member.

5. The method of claim 3, wherein the connection strength of a secondary company connected member is calculated based on the secondary company connected member having also connected with another company secondary connected member.

6. The method of claim 1, further comprising:
determining a first skill set for the member based on skills included in a profile of the member; and
determining a skill set for each of the company connected member based on skills included in respective profiles of the company connected members, wherein the connection strength between the member and the company connected member is based on a similarity between the first skill set and the skill set of the company connected member.

7. The method of claim 1, wherein the connection strength between the member and each company connected member is calculated based on a job title of the respective company connected member.

8. The method of claim 1, further comprising:
determining a network affinity between the member and the company based on network interactions between the member and the company, wherein the calculating the leverage score for the company is based on the connection strengths of the company connected members and the network affinity of the member and the company.

9. The method of claim 8, wherein the network interactions include social interactions between the member and the company connected members.

10. The method of claim 8, further comprising:
determining a member skill set for the member based on skills included in a profile of the member;
identifying proxy members that have a skill set similar to the member skill set;
providing proxy members with survey questions;
receiving survey answers from the proxy members in response to the survey questions, wherein the network interactions are based on the survey answers from the proxy members.

11. A system comprising:
at least one processor of a machine; and
a memory storing instructions that, when executed by the at least one processor, cause the machine to perform operations comprising:
identifying, by a server having at least one processor, a plurality of jobs in response to a search for jobs for a member, each job being offered by a company from a plurality of companies;
identifying connected members of the member in a social network, each connected member being associated with a connection strength;
for each company offering at least one of the jobs, identifying company connected members as the connected members of the member that are working for the company or that previously worked for the company; and
for each company, calculating a leverage score for the company based on the connection strengths of the company connected members;
ranking the plurality of jobs based on the leverage scores; and
causing a presentation of jobs from the plurality of jobs based on the ranking.

12. The system of claim 11, wherein the company connected members include a subset of primary company connected members and a subset of secondary company connected members, a primary company connected member being a member on the social network that is directly connected with the member on the social network, a secondary company connected member being a member on the social network that is not directly connected with the member and is directly connected with at least one of the primary connected members of the member.

13. The system of claim 12, wherein the leverage score for the company is calculated based on the connection strengths of the subset of primary company connected members.

14. The system of claim 13, wherein the connection strength of a company primary connected member is calculated based on the company primary connected member having also connected with another company primary connected member.

15. The system of claim 13, wherein the connection strength of a secondary company connected member is calculated based on the secondary company connected member having also connected with another company secondary connected member.

16. The system of claim 1, wherein operations further comprise:
determining a first skill set for the member based on skills included in a profile of the member; and
determining a skill set for each of the company connected members based on skills included in respective profiles of the company connected members, wherein the connection strength between the member and the company connected member is based on a similarity between the first skill set and the skill set of the company connected member.

17. The system of claim 11, wherein the connection strength between the member and each company connected member is calculated based on a job title of the respective company connected member.

18. The system of claim 11, further comprising:
determining a network affinity between the member and the company based on network interactions between the member and the company, wherein the calculating the leverage score for the company is based on the connection strengths of the company connected members and the network affinity of the member and the company.

19. The system of claim 18, wherein operations further comprise:
determining a member skill set for the member based on skills included in a profile of the member;
identifying proxy members that have a skill set similar to the member skill set;
providing the proxy members with survey questions;
receiving survey answers from the proxy members in response to the survey questions, wherein the network interactions are based on the survey answers from the proxy members.

20. A non-transitory machine-readable storage medium comprising instructions that, when executed by one or more processors of a machine, cause the machine to perform operations comprising:
identifying, by a server having at least one processor, a plurality of jabs in response to a search for jobs for a member, each job being offered by a company from a plurality of companies;
identifying connected members of the member in a social network, each connected member being associated with a connection strength;
for each company offering at least one of the jobs, identifying company connected members as the connected members of the member that are working for the company or that previously worked for the company; and
for each company, calculating a leverage score for the company based on the connection strengths of the company connected members;
ranking the plurality of jobs based on the leverage scores; and
causing a presentation of jobs from the plurality of jobs based on the ranking.
